(19) United States
(12) Patent Application Publication
(10) Pub. No.: US 2008/0199628 A1
(43) Pub. Date: Aug. 21, 2008

(54) Masking system using temperature-resistant hook and loop fasteners

(75) Inventor: John E. Markowski, Berlin, CT (US)

Correspondence Address: Theodore W. Olds, Suite 350, 400 West Maple Road, Birmingham, MI, 48009, US

(73) Assignee: United Technologies Corporation

(21) Appl. No.: 11/706,651

(22) Filed: Feb. 15, 2007

(51) Int. Cl. B05D 1/32

(52) U.S. Cl. 427/448; 118/721

(57) ABSTRACT

A method of masking portions of a part from a high temperature coating, such as a plasma flame spray coating includes mask elements that extend between spaced ends. Hook and loop fasteners are associated with the two spaced ends. The hook and loop fasteners are of a material that can withstand very high temperatures such as are experienced in the high temperature coating. The hook and loop fastener elements may be metallic elements. While a single mask element may be utilized to wrap around the part, in another embodiment, a plurality of mask pieces can be assembled together to surround the part.

### BACKGROUND OF THE INVENTION

This application relates to a method of masking a part to control the portions of the part that are subject to high temperature spray coating, in which the masking element has a hook and loop type fastener to secure the masking element to the part.

Various types of high temperature spraying are utilized to coat or otherwise treat parts in industrial operations. One type of high temperature spraying is plasma spraying. In plasma spraying, a material is coated onto selected locations on a part. Other portions of the part are masked such that the coating will not occur on those parts.

A rubber mask has often been utilized to cover the portions that are not to be coated. The rubber mask has traditionally been a continuous band of rubber. This band must be stretched over the portions of the part which are to be masked. This requires the operators to stretch the mask over the part, and is somewhat difficult to perform.

In other known masking techniques, the rubber mask may be split. Tape has been utilized to hold ends together. The tape is time consuming to use, and a special pattern has been used to ensure the tape does not come undone during the treatment. The taping requires specific training and skill by the operator who is to assemble the mask.

Also, a rubber tape has been applied to the part. This is perhaps the most labor-intensive way to mask the part. This requires a skilled operator and a good deal of time even compared to other masking techniques. Furthermore, operators who routinely perform this technique are sometimes subject to carpel tunnel syndrome, and other potential injuries.

Hook and loop type fasteners are known, and have been utilized in many applications. There are hook and loop type fasteners that are resistant to high temperatures. However, such hook and loop type fasteners have never been applied in combination with masks for plasma spray operations, or other high temperature spray coatings.

### SUMMARY OF THE INVENTION

In a disclosed embodiment of this invention, a mask for masking a portion of a part to be subject to a high temperature coating operation has two distinct ends. A hook fastener portion is formed at one end, and a loop fastener portion is formed at the other. The hook and loop fasteners are resistant to high temperatures. In one embodiment, they may be metallic. Other materials may also be used. By providing the hook and loop type fastener, the mask may be easily placed around the part to be covered. Furthermore, the hook and loop type fastener is resistant to the high temperatures that are involved in the coating, and can be re-utilized. In general, the hook and loop type fasteners will survive for about as many coating operations as the rubber masking itself is usable. Typically, this would mean 5 to 10 spray operations. The high temperature coating operation is disclosed as a plasma spray coating, however the mask can be used in any type coating where masks are utilized.

In one embodiment, a single long strip of rubber mask material is provided with the hook and loop type fasteners at two distinct ends. This long strip is wrapped around the part. In another embodiment, shorter strip pieces are provided, each having a hook portion at one end and a loop portion at the other end. These several pieces can then be assembled together to conform to the specific size and shape of the part to be covered. In general, the mask is formed of a silicone rubber, as has been utilized in the prior art.

These and other features of the present invention can be best understood from the following specification and drawings, the following of which is a brief description.

### BRIEF DESCRIPTION OF THE DRAWINGS

FIG. 1 is a perspective view of a part to be coated with a plasma spray operation, and having parts covered by mask elements.

FIG. 2 shows a first portion of the inventive mask element.

FIG. 3 shows the mask element of this invention secured together.

FIG. 4 shows another embodiment.

### DETAILED DESCRIPTION OF THE PREFERRED EMBODIMENT

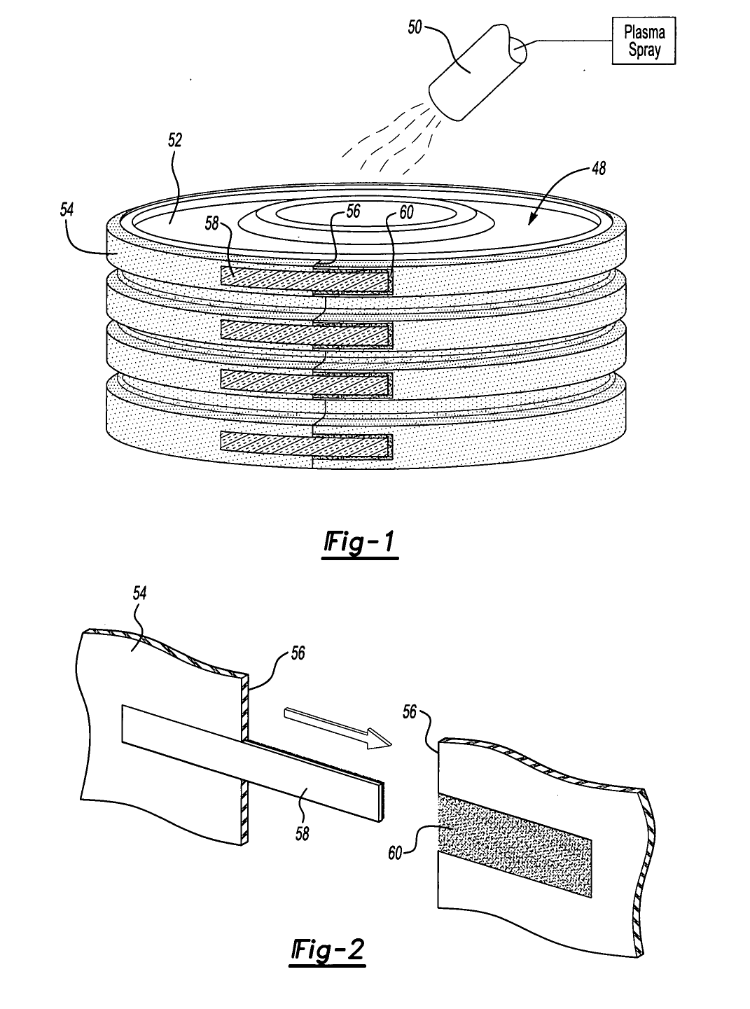

A part 48 that is to be subject to plasma spray coating (shown schematically at 50) is shown in FIG. 1. A portion 52 is to be coated by the plasma spray coating. The high temperature coating operation is disclosed as a plasma spray coating, however the mask can be used in any type coating where masks are utilized.

Portion are covered by masks 54. As shown, there are several masks 54 assembled on the part 48. The part shown is exemplary only, and the masking technique of this application can extend to many distinct types of parts. Applicant believes the inventive mask will especially benefit gas turbine engine components such as rotors, shafts, etc., that are to be coated. Even so, other parts to be coated by any high temperature coating technique will benefit from this invention.

As shown in FIG. 1, the mask 54 includes ends 56 that abut together, and a hook portion 58, which assembles onto a loop portion 60. The mask material is a silicone rubber. Thus, the strip may be easily attached to the part 48, and may be easily removed. The hook and loop type fasteners are formed of a temperature resistant material. The material is disclosed as metallic, and may be stainless steel, brass, bronze, copper or any other alloy which can withstand direct flame contact. On the other hand, other non-metallic materials that can withstand the high temperatures, may also be utilized.

As shown in FIG. 2, the strip 54 has the ends 56 spaced from each other. The hook portion 58 secures onto the loop portion 60, as known. The specific metallic hook and loop type fastener material is known, however, it has never been utilized in such an application. Generally, the parts and the mask have to withstand temperatures of at least about 300° F. (approximately 149° C.) or higher.

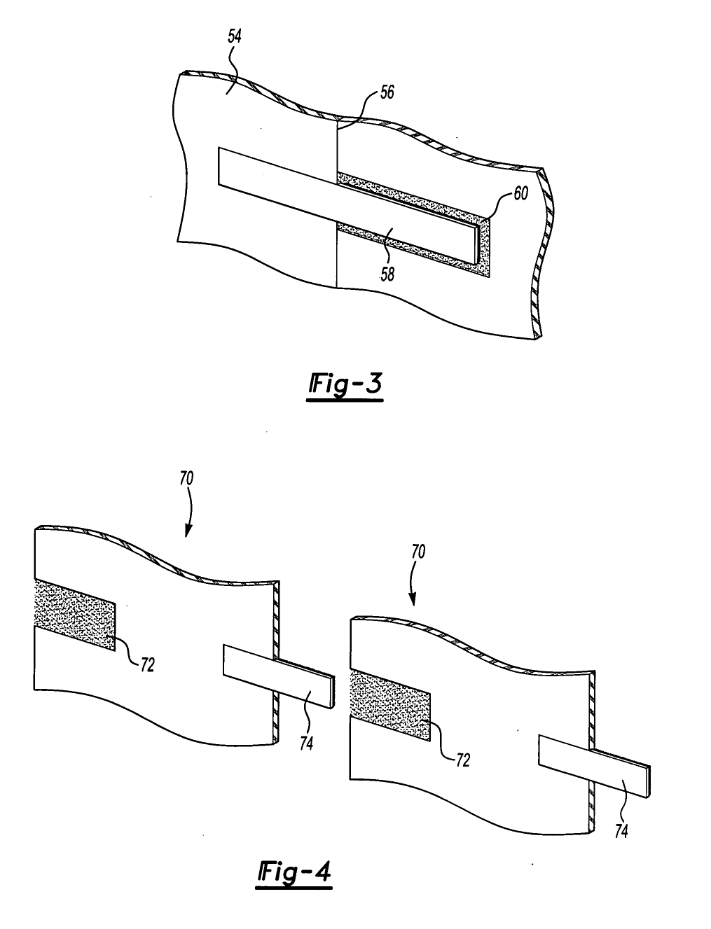

FIG. 3 shows the two ends secured together with the hook material 58 secured onto the loop material 60.

One commercially available hook and loop type fastener is that available under the trademark Hi-Garde® available from Velcro. This hook and loop type fastener is constructed with stainless steel and can be utilized up to 800° F. (approximately 426° C.). Another material that may be utilized is available from McMaster Carr. An acceptable hook material is identified by part number 96225K41, and an acceptable loop material is identified by part number 96225K61. Of course, other materials capable of withstanding the temperature ranges expected to be experienced in the plasma flame spray coating may be utilized.

FIG. 4 shows another embodiment wherein there are several shorter pieces 70. These segments may be assembled together with their hook portions 74 secured to a loop portion 72 on an adjacent piece 70. With this embodiment, a plurality of the segments can be selected to correspond to specific size or shape of the part to be subject to the plasma spray technique.

When the coating is complete with the inventive methods, the next step taken is to remove the mask. With the inventive hook and loop type fasteners, the mask and its hook and loop type fasteners may be re-utilized to coat a second part. It is believed the hook and loop fasteners can be re-used for as many times as the masks (5-6 coatings).

In addition, the use of the hook and loop type fasteners allows for more convenient storage of the masking elements. The masking elements can be hung by the fastener vertically, which is more space-efficient than the storage techniques that have been utilized for the band of rubber masks known in the part art.

While embodiments of this invention have been disclosed, a worker of ordinary skill in the art would recognize that certain modifications would come within the scope of this invention. For that reason, the following claims should be studied to determine the true scope and content of this invention.

What is claimed is:

1. A method of coating a part comprising the steps of:
(a) defining a part to be coated by a high temperature coating technique;
(b) providing a mask element, said mask element having two ends, with a hook portion associated with one of said two ends and a loop portion associated with the other of said two ends, said hook and loop portions being operable to come together to secure the two ends to each other, and said hook and loop portions being formed of a material which is resistant to high temperature;
(c) wrapping the mask around the part, on an area to be masked from coating, and securing the hook portion to the loop portion; and
(d) providing the high temperature coating technique to the part.

2. The method as set forth in claim 1, wherein said hook and loop portions are formed of a metallic material.

3. The method as set forth in claim 1, wherein said mask element is formed of a rubber material.

4. The method as set forth in claim 1, wherein said mask element is one generally elongate strip.

5. The method as set forth in claim 1, wherein said mask element is formed of a plurality of discrete mask pieces, with each of said mask pieces having two ends, a hook portion at one end and a loop portion at the other, with the plurality of mask pieces being assembled together by attaching the hook portion of one piece to the loop portion of another piece.

6. The method as set forth in claim 1, wherein after step (d) the mask element is removed, and is then re-attached to a subsequent part to be coated, re-using the hook and loop portions.

7. The method of claim 1, where the high temperature coating technique is a plasma spray coating.

8. A mask element for use in a high temperature coating technique comprising:
a body extending between two ends, a hook portion associated with one end and a loop portion associated with a second end, said hook and loop portions being formed of a material which is resistant to high temperatures.

9. The mask element as set forth in claim 8, wherein said hook and loop portions are formed of a metallic material.

10. The mask element as set forth in claim 8, wherein there is one generally elongated mask member that is to be wrapped around a part to be protected from coating.

11. The mask element as set forth in claim 8, wherein a plurality of discrete mask pieces each include a hook and loop portion which are secured together to provide a combined mask having an appropriate size for the particular part to be protected.

12. The mask element as set forth in claim 8, wherein said body is formed of a silicone rubber.

13. The mask element as set forth in claim 8, wherein said hook and loop portions are formed of a material capable of withstanding temperatures at least as high as about 149° C.
